(19) United States
(12) Patent Application Publication
(10) Pub. No.: US 2023/0324688 A1
(43) Pub. Date: Oct. 12, 2023

(54) AR HEADSET OPTICAL SYSTEM WITH SEVERAL DISPLAY SOURCES

(71) Applicant: AURORATECH COMPANY, San Francisco, CA (US)

(72) Inventors: Ziqi Peng, Burlingame, CA (US); Justin Krenz, Oakland, CA (US); Bayley Wang, Los Gatos, CA (US)

(73) Assignee: AURORATECH COMPANY, San Francisco, CA (US)

(21) Appl. No.: 18/134,017

(22) Filed: Apr. 12, 2023

Related U.S. Application Data
(60) Provisional application No. 63/329,988, filed on Apr. 12, 2022.

(51) Int. Cl. G02B 27/01; G02B 27/18; G02B 27/09

(52) U.S. Cl. CPC G02B 27/0172; G02B 27/18; G02B 27/0972; G02B 27/0977

(57) ABSTRACT

An AR headset optical system that includes a wide field of view, a waveguide or lightguide eyepiece, and several display sources. The augmented reality headset (ARHS) utilizes a display system that incorporates a projection engine containing two or more displays. The displays are each associated with a projection system, the displays and projection systems are aligned with each other to create a field-of-view (FOV) of at least 60 degrees.

### CROSS-REFERENCE TO RELATED APPLICATIONS

This is a utility patent application being filed in the United States as a non-provisional application for patent under Title 35 U.S.C. § 100 et seq. and 37 C.F.R. § 1.53(b) and, claiming the benefit of the prior filing date under Title 35, U.S.C. § 119(e) of the United States provisional application for patent that was filed on Apr. 12, 2022 and assigned Ser. No. 63/329,988, which application is incorporated herein by reference in its entirety.

### BACKGROUND

An augmented reality headset (ARHS) is a type of wearable display apparatus where the viewer is able to see both virtual, computer-generated images and the physical world. For this reason such devices are sometimes known as see-through head-mounted displays (HMDs). Throughout this description, the terms computer-generated images and virtual images are the same and can be interchanged.

One of the components of an ARHS is the eyepiece, or combiner, the optical element which steers the light from the computer-generated images so that it is overlaid on top of the transmitted image from the physical world. In most embodiments, the combiner serves to act as a tilted, partially-reflecting mirror which deflects a portion of the light from the virtual image to the wearer's eye while also allowing a portion of the light from the physical world to be transmitted to the wearer's eye.

The light from the computer-generated images is produced by a display engine, which consists of one or more display sources and a projection system having zero or more optical elements. The display sources take a digital or analog representation of the image and convert it to optical output which is controlled by that representation—for example, such a display source could be a digital micromirror device, cathode-ray tube, organic LED display, inorganic LED display, liquid-crystal-on-silicon display, liquid crystal display, or tricolor laser source. The projection system manipulates light in conjunction with the eyepiece such that the final effect is to project a sharp real image to the wearer's eye such that the image appears to come from in front of the wearer.

The interaction between the eyepiece and the display engine is critical to meeting the performance requirements of the ARHS, namely, the field-of-view, transparency, optical efficiency, contrast, sharpness, and size. There are frequently trade-offs between the performance specifications; for example, a wider field-of-view requires a shorter focal length projection optical system which results in a faster focal ratio, causing the optical system to become larger. It is evident that an optical system which can circumvent some of these trade-offs would improve the overall performance of the ARHS and advance the state of ARHS optical systems as a whole.

### BRIEF SUMMARY

The present disclosure is related to AR headset optical systems, specifically AR headset optical systems with a wide field of view, a waveguide or lightguide eyepiece, and several display sources.

### BRIEF DESCRIPTION OF THE DRAWINGS

FIG. 1 depicts a high-level view of the operation of an augmented reality headset (ARHS).

FIG. 2 depicts an embodiment of an ARHS optical system using a large partial reflector.

FIG. 3 depicts an embodiment of an ARHS optical system using a reflective/refractive system.

FIG. 4 depicts an embodiment of an ARHS optical system using a reflective hologram.

FIG. 5 depicts an embodiment of an ARHS optical system using a diffraction grating.

FIG. 6 depicts a lightguide.

FIG. 7 depicts an embodiment of an ARHS optical system using a lightguide eyepiece.

FIG. 8 depicts a lightguide eyepiece having sparse reflectors embedded within it.

FIG. 9 depicts a lightguide eyepiece having multiple partially reflecting mirrors embedded within it.

FIG. 10 depicts an embodiment of a display engine.

FIG. 11 depicts the path of light through an ARHS eyepiece from the display engine.

FIG. 12 depicts a display engine with more than one display.

FIG. 13 depicts a display engine with more than one display in conjunction with a waveguide eyepiece.

FIG. 14 depicts a display engine with more than one display wherein the light is manipulated with prisms.

FIG. 15 depicts a display engine with more than one display wherein the multiple displays are bonded to a flat substrate.

FIG. 16 depicts a display engine with more than one display wherein the multiple displays are logical segments of a single large display.

FIG. 17 depicts a display engine with more than one display wherein a beamsplitter(s) are used to virtually abut the displays.

### DETAILED DESCRIPTION OF EXEMPLARY EMBODIMENTS

The present invention is directed towards an augmented reality headset (ARHS), and more particularly, a ARHS that utilizes a display system that incorporates a projection engine which contains two or more displays. The displays are each associated with a projection system, the displays and projection systems are aligned with each other to create a field-of-view (FOV) of at least 60 degrees. In one embodiment of the ARHS, prisms, or optical elements, such as diffractive, Fresnel, or kinoform elements having the same function as a prism, are adjusted to align the sub-images formed by the several projection engines to within one-half of a pixel.

In some embodiments of the ARHS, the displays are microdisplays having a maximum dimension of less than 3 inches, or utilize temporally multiplexed displays. In some embodiments, multiple displays are utilized and at least two of the displays have different specifications. Further, in some embodiments, the display system uses a waveguide eyepiece along with a projection engine to redirect light into a viewer's eyes. In such embodiments, the waveguide eyepiece may contain a sparse distribution of small mirrors to redirect the light.

In other embodiments, the display system of claim may use displays that are coplanar. In such embodiments, the coplanar displays may include separate devices aligned and packaged with the same planar substrate. Further, the coplanar displays may include different regions of the same physical display with large size.

In embodiments that utilize optical prisms or mirrors in the display, such optics advantageously cause the displays to appear seamlessly abutted to each other in order to reduce the size and improve the field of view of the system. Other advantages of the various embodiments include the projection engine being under 20 mm, an eyebox that has dimension of at least 20 mm, and a waveguide eyepiece that is used in conjunction with the projection engine to redirect light into the viewer's eye.

These and other aspects, features and advantages of the various embodiments are more specifically described below in connection with the drawings and the description of the drawings.

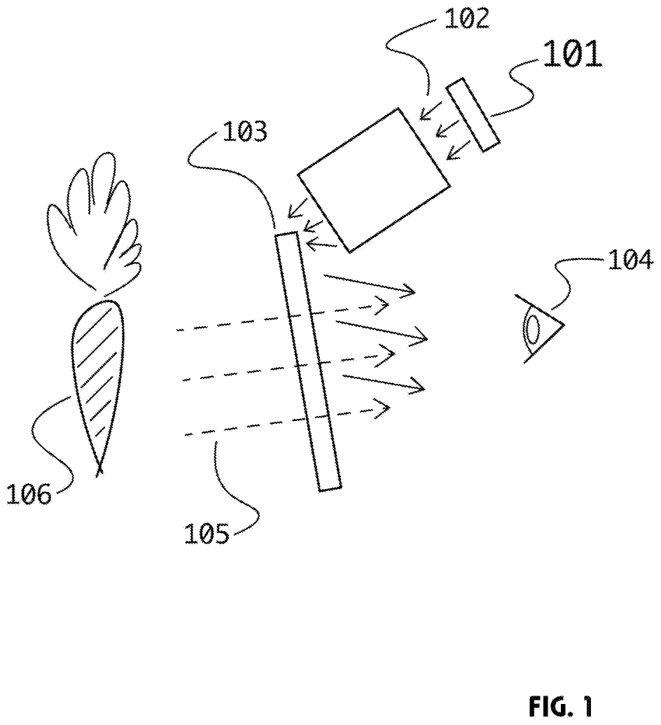

FIG. 1 depicts the optical path of an augmented reality headset (ARHS). A digital display 101 connected to a computing device (not shown) displays a virtual image, the light 102 of which is transmitted through a projection module consisting of several (possibly zero) optical elements onto a eyepiece or combiner 103. The combiner redirects a portion of the light 102 into the wearer 104's eye, while also letting a portion of the light 105 from real objects 106 in the wearer's environment be transmitted to the wearer's eye. The overall effect is as if virtual images on the display generated by the computing device are placed in the wearer's environment.

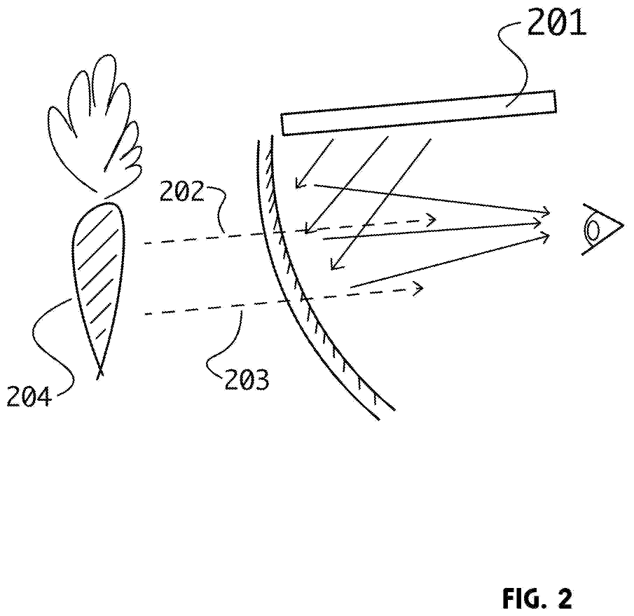

FIG. 2 depicts one embodiment of the eyepiece or combiner in which the light emitted by the display(s) 201 is reflected from the curved, partially silvered reflector 202 towards the wearer's eye. Either the front or back surface of the reflector is silvered, with the other being transparent, and the overall thickness and curvature of the two surfaces is such that the light 203 from objects 204 in the wearer's environment is transmitted undistorted to the wearer's eye.

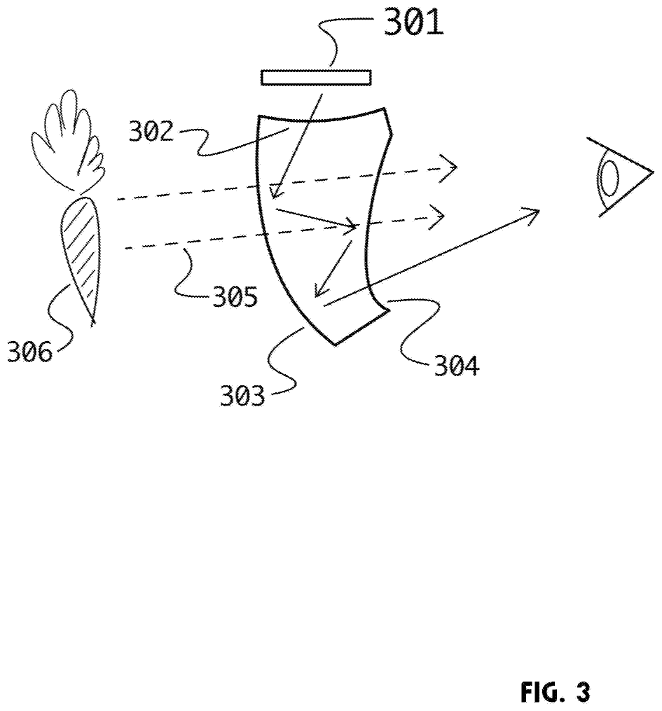

FIG. 3 depicts another embodiment of the eyepiece or combiner in which light emitted by the display(s) 301 is reflected and refracted several times through a series of optically powered surfaces 302, 303, 304, which, in some embodiments, are the surfaces of one or more optical prisms placed in front of the wearer's eye. This system allows for the generation of a large field of view (FOV) by magnifying a smaller display while allowing light 305 from objects 306 in the wearer's environment to be transmitted undistorted to the wearer's eye.

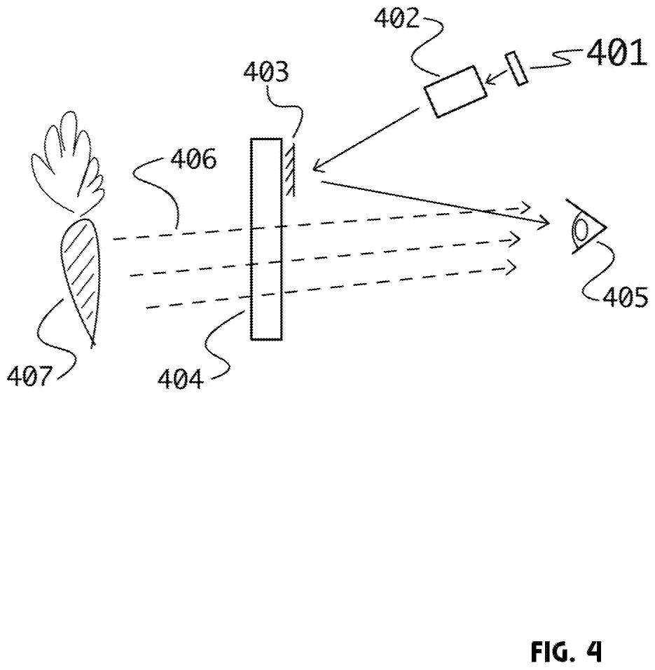

FIG. 4 depicts another embodiment of the eyepiece or combiner in which light emitted by the display(s) 401, which in some embodiments are temporally interlaced laser scanning system(s), is transmitted and/or reflected by a projection system 402 having zero or more elements before reflecting off of a hologram 403 on a eyewear lens 404 (which, in some embodiments is a prescription eyeglass lens). This hologram acts as a optically powered elements which redirects and focuses light to the wearer's eye 405; the mostly clear aperture of the eyewear lens allows light 406 from objects 407 in the wearer's environment to be transmitted undistorted to the wearer's eye.

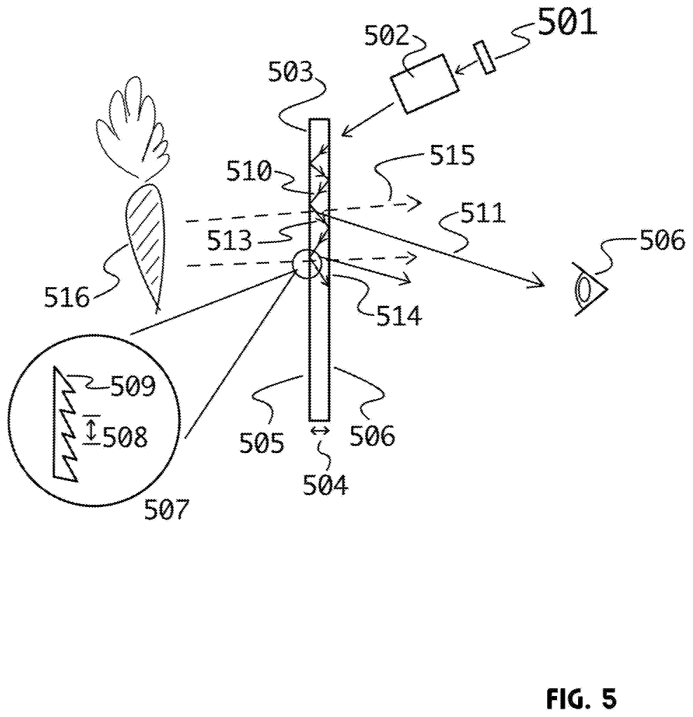

FIG. 5 depicts another embodiment of the eyepiece or combiner in which light 502 emitted by the displays 501, which in some embodiments are micro-projector(s) utilizing OLED, inorganic LED, liquid crystal, LCOS, or DMD display(s), in some embodiments are microdisplay(s) having maximum dimension under 3 inches, and in some embodiments are projected or multiplexed displays such as, but not limited to, a laser beam scanning system, is transmitted and/or reflected by a projection system having zero or more elements before being coupled into the thin waveguide 503 which has a thickness 504 comparable to one wavelength of visible light. The material of the waveguide has a higher refractive index than the surrounding air and therefore the light is confined to the propagation modes of this waveguide. One or both of the surfaces 505 and 506 of this waveguide has a nano-structured diffraction grating (detail 507) affixed to it. In some embodiments this grating is a blazed grating; in other embodiments it could be a complex metasurface. The pitch or spacing 508 of individual elements 509 of this grating is equal to or less than a wavelength of visible light. The interaction between the propagating light 510 and the diffraction grating redirects some of the light 511 in such a way that it leaks from the waveguide and enters the wearer's eye 512. Some of the propagating light 513 is redirected in a way that does not enter the viewer's eye; the remainder of the light 514 continues through the waveguide and is subsequently redirected by further interaction with the diffraction grating. Transmitted light 515 from objects 516 in the viewer's environment passes through the diffraction grating where based on the wavelength of the transmitted light, it gets diffracted at different angles.

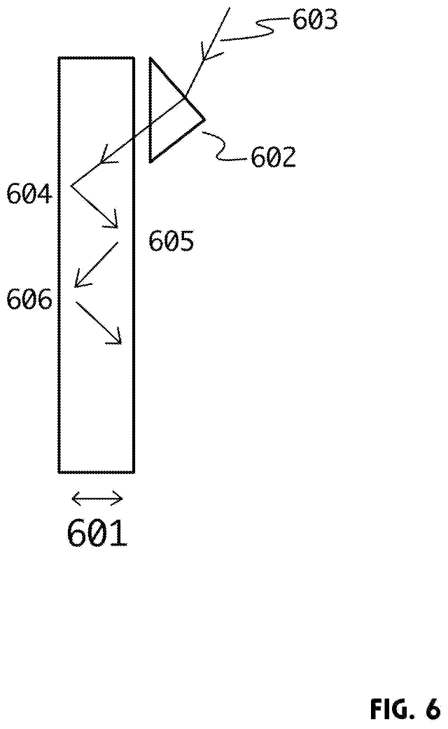

FIG. 6 depicts a lightguide. A lightguide is similar to a waveguide, with the exception that the dimensions 601 are all much larger than a wavelength of light; for example, 1 mm or more. A coupling element 602 injects light 603 into the body of the lightguide where it is confined by total internal reflection 604, 605, 606 and propagates inside the lightguide. The behavior of the lightguide can be analyzed in the geometric regime.

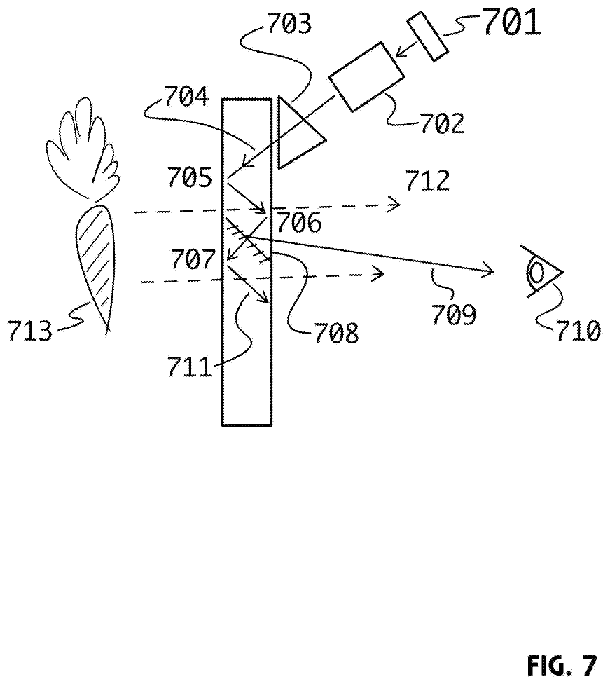

FIG. 7 depicts another embodiment of the eyepiece or combiner in which light emitted by the displays 701 which is some embodiments are temporally interlaced laser scanning system(s) and in some embodiments are micro-projector(s) utilizing OLED, inorganic LED, liquid crystal, LCOS, or DMD microdisplay(s), in some embodiments are microdisplay(s) having maximum dimension under 3 inches, and in some embodiments are projected or multiplexed displays such as, but not limited to, a laser beam scanning system, is transmitted and/or reflected by a projection system 702 having zero or more elements before entering the coupling element 703 which in some embodiments is a diffraction grating and in some embodiments is a refracting prism. The coupling element injects light 704 from the display into the lightguide where it is confined by total internal reflection 705, 706, 707. As the light propagates through the lightguide it encounters one or more slanted mirrors 708 which are arranged to allow a portion 709 of the propagating light to be redirected to the wearer's eye 710, and allows a portion 711 of the propagating light to continue to propagate through the lightguide. The slanted mirrors are also arranged in a way which allows transmitted light 712 from objects 713 in the wearer's environment to reach the viewer's eye.

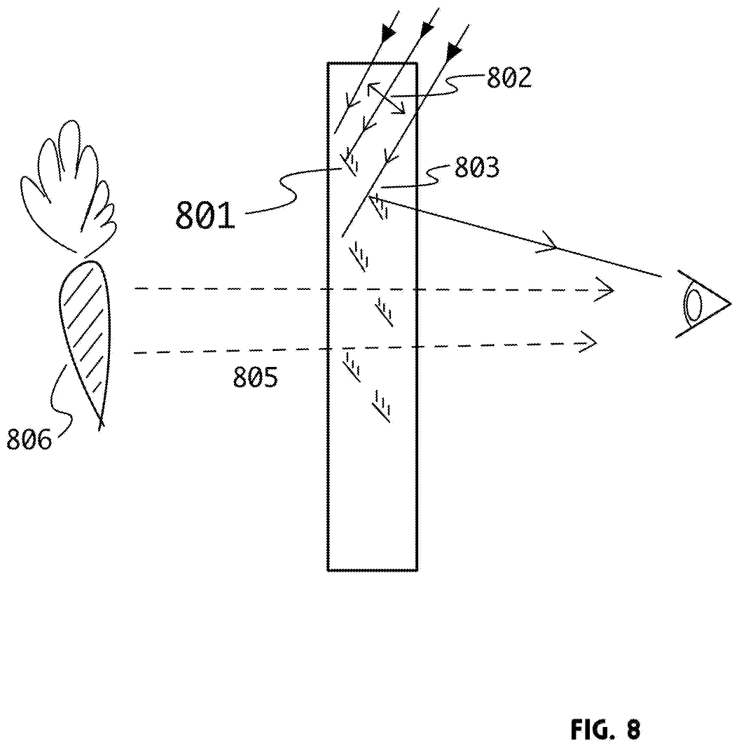

FIG. 8 depicts one embodiment of a lightguide eyepiece in which the slanted mirrors are arranged as a sparse distribution of small mirrors 801 with dimensions on the order of 1 mm such that the propagating beam of light 802 has dimension larger than that of the slanted mirror. In some embodiments, these mirrors are fully reflective mirrors across the operating wavelengths of the eyepiece. In other embodiments, these mirrors are a special coating, for example, but not limited to, a multi-band dielectric mirror, a holographic mirror, a polarization-sensitive coating, or a nano-structured coating. As the light propagates through the lightguide it encounters mirrors which redirect a small portion 803 of the light to the wearer's eye 804, while allowing the remaining portion of light to continue propagating. Similarly, light 805 from objects 806 in the wearer's environment is allowed to transmit through the gaps between the mirrors in an undistorted fashion. The positions and shapes of the small mirrors 801 can be determined with an automatic optimization algorithm which maximizes a user selected description of the merit of the arrangement, for example, some weighted combination of parameters including, but not limited too, image uniformity, efficiency, and stray light.

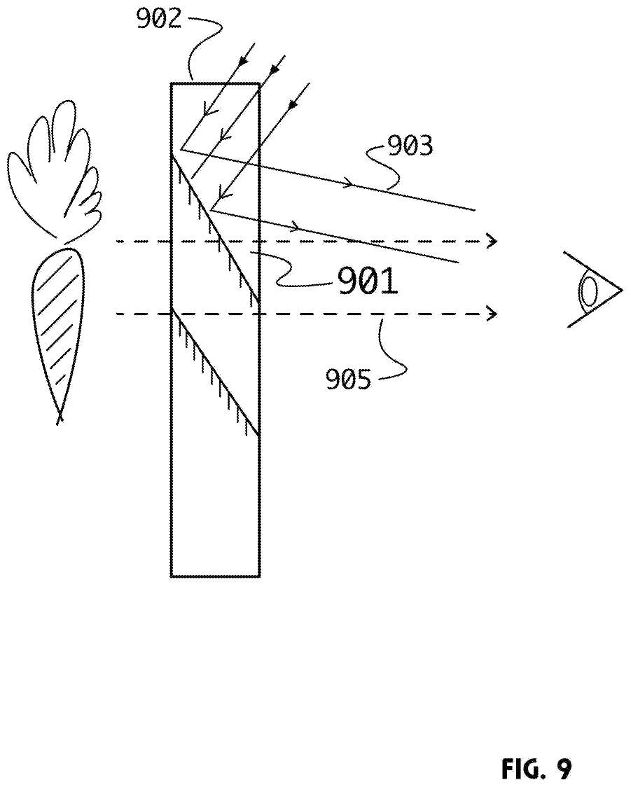

FIG. 9 depicts another embodiment of a lightguide eyepiece in which the slanted mirrors are arranged as one or more large, partially reflective mirrors 901 with dimensions similar to those of the propagating beam of light 902. In some embodiments, these mirrors are partially reflective silver mirrors. In other embodiments, these mirrors are a special coating, for example, but not limited to, a a multi-band dielectric mirror, a holographic mirror, a polarization-sensitive coating, or a nano-structured coating. As light propagates through the lightguide it encounters mirrors which reflect a fraction of the power in the beam 902 to the beam 903 which reaches the wearer's eye 904 while allowing the remaining power to continue propagating. Light 905 from objects 906 in the wearer's environment is partially transmitted through the partially reflecting mirrors and allowed to reach the wearer's eye in an undistorted fashion.

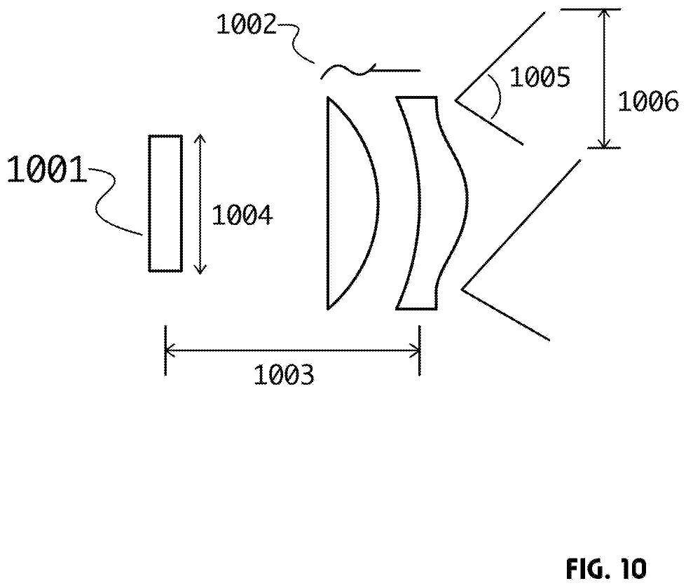

In the above-described embodiments, the combination of the display(s) and projection system(s) is called the display engine. FIG. 10 depicts a basic embodiment of a display engine, in which light from a single display 1001 which in some embodiments is an OLED, inorganic LED, liquid crystal, LCOS, or DMD display, in some embodiments is a microdisplay having maximum dimension under 3 inches, and in some embodiments is a projected or multiplexed display such as, but not limited to, a laser beam scanning system or a micro-LED scanned display having one or two axes of scanning, is collected by the projection lens 1002 which can be composed of lenses, mirrors, diffractive elements, kinoform elements, or Fresnel elements which in turn could be spherical, aspherical, or freeform. In some further embodiments display 1001 is a virtual image plane of a projected display located elsewhere. The focal length 1003 of the projection lens and the lateral dimension of the display 1004 determine the field of view 1005 and the exit pupil diameter 1006 of the lens is related to the eyebox size of the overall AR system, which determines the range of valid positions where the wearer's eye may sit. It is desirable to have a large field of view (for example, greater than 50-60 degrees) in order to provide a more immersive viewing experience with peripheral awareness and a large eyebox size in order to allow for variances in wearer interpupillary distance, device positioning on the wearer's head, and pupil motion during use. This means the focal length 1003 should be small and the exit pupil diameter should be large, which necessitates a fast focal ratio.

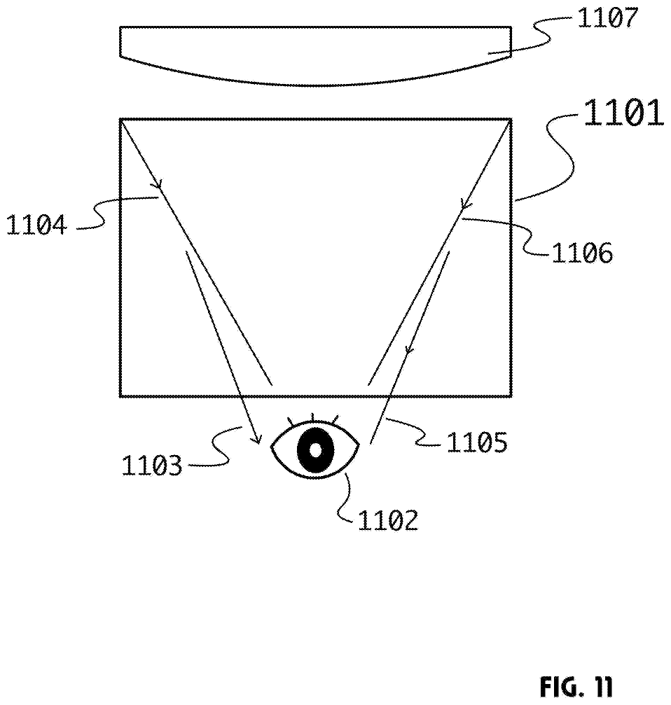

In some embodiments of the AR display system, a waveguide or lightguide eyepiece is used to couple light from the display engine to the wearer's eye. FIG. 11 depicts the path of light through such an eyepiece. Light exiting the eyepiece 1101 reaches the wearer's eye 1102. Light 1103 corresponding to fields to the left of the wearer's eye must follow the path 1104 through the eyepiece, and likewise light 1105 corresponding to the fields to the right of the wearer's eye must follow the path 1106 through the eyepiece. This requires the projection system have elements 1107 which span the entire width of the eyepiece, which can pose challenges in the design of a compact projection system, especially if a large field of view (for example, greater than 50-60 degrees) is desired.

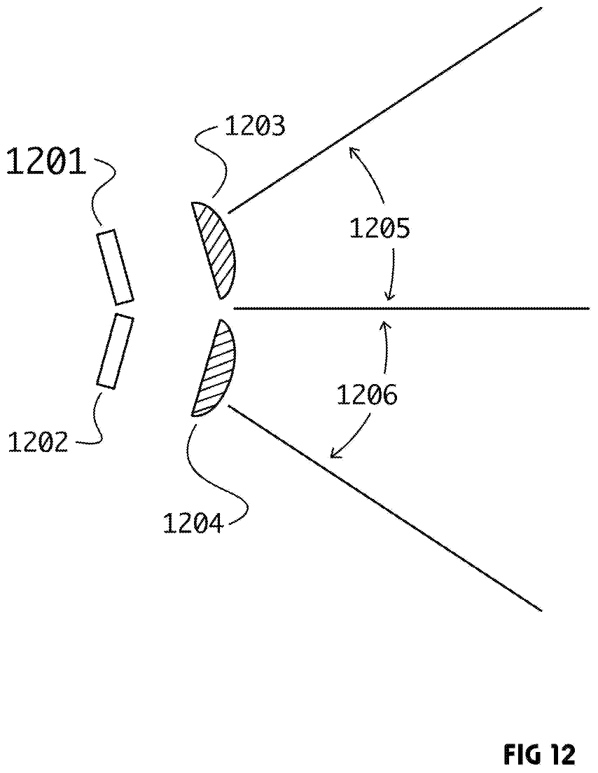

FIG. 12 depicts an advancement of the basic projection engine in which two or more displays 1201, 1202 which in some embodiments is an OLED, inorganic LED, liquid crystal, LCOS, or DMD display, in some embodiments is further a microdisplay having maximum dimension under 3 inches, and in some embodiments are projected or multiplexed displays such as, but not limited to, a laser beam scanning system, which need not be identical in specifications or type, and two more more projection lenses 1203, 1204 which need not be identical are utilized. The display 1201 and projection lens 1203 form one sub-engine which creates a segment 1205 of the field of view, likewise 1202 and 1204 create segment 1206. The two segments are aligned such that the field of view seen by the viewer has no gaps. This allows for the generation of a large field of view (for example, greater than 50-60 degrees) while maintaining a number of advantages. For example, the focal ratio of the lenses 1203 and 1204 can be larger (slower) than if the projection engine contained just one display. The number of sub-engines shown is exemplary—there may be greater than two sub-engines.

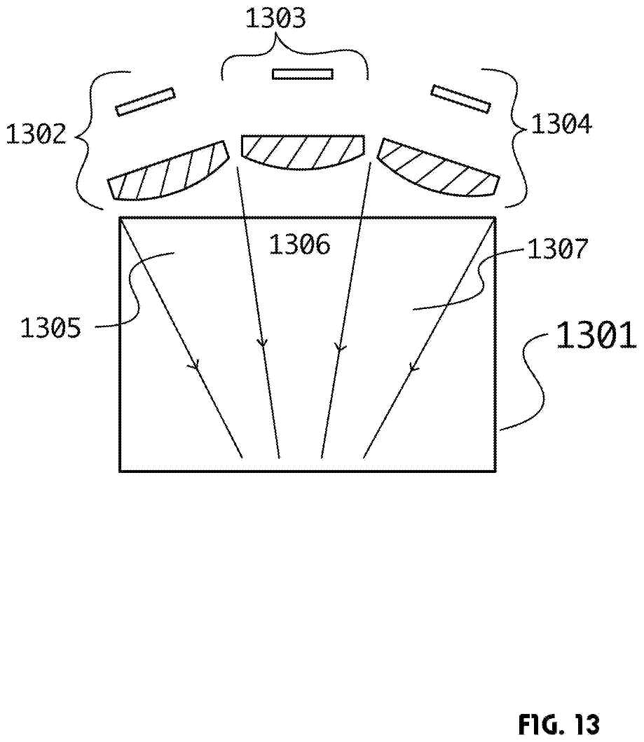

FIG. 13 depicts the type of projection engine in FIG. 12 in combination with a waveguide or lightguide eyepiece 1301 which may be of the types shown in FIGS. 5-9. Sub-engines 1302, 1303, 1304 are oriented and placed such that the light 1305, 1306, 13070 respectively emitted by the sub-engines propagates through the eyepiece along the paths depicted in FIG. 11 so that the light received by the wearer's eye forms a complete image which a large field of view, for example greater than 50-60 degrees. This allows for an increased degree of control of the light paths which allows for a larger field of view while maintaining a compact size of projection engine versus a projection engine with just one display.

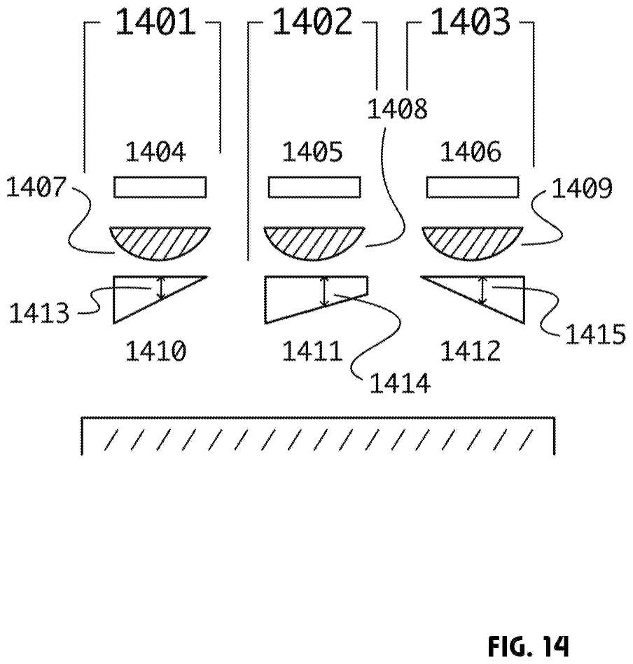

The alignment of the projection engine in FIGS. 12 and 13 can be challenging, especially as the number of sub-engines increases, since the sub-engines need to be repeatably aligned and positioned to within one angular sub-pixel (for example, one-quarter to one-half of the angle subtended by a single pixel on the displays). FIG. 14 depicts a method to control the angular direction of the output of the sub-engines without having to mechanically align the individual sub-engines. The sub-engines 1401, 1402, 1403 utilizing displays 1404, 1405, 1406 and projection lenses 1407, 1408, 1409 have at their output prisms 1410, 1411, 1412. The apex angles 1413, 1414, 1415 of the prisms as well as the overall orientation and position of the prisms, can be adjusted so that the output light 1416, 1417, 1418 together form a complete image with a large field of view, for example greater than 50 degrees diagonally. In some embodiments the prisms are replaced by diffractive, kinoform, Fresnel, or holographic elements having the same optical function as a prism and in some further embodiments, the prisms are not triangular, but polyhedral. In some embodiments, the prisms 1410˜1412 are fabricated as a single element and in some embodiments, the prisms 1410˜1412 contain one or more optically powered surfaces, which can be refractive, diffractive, kinoform, or Fresnel and may be spherical, aspherical, or freeform.

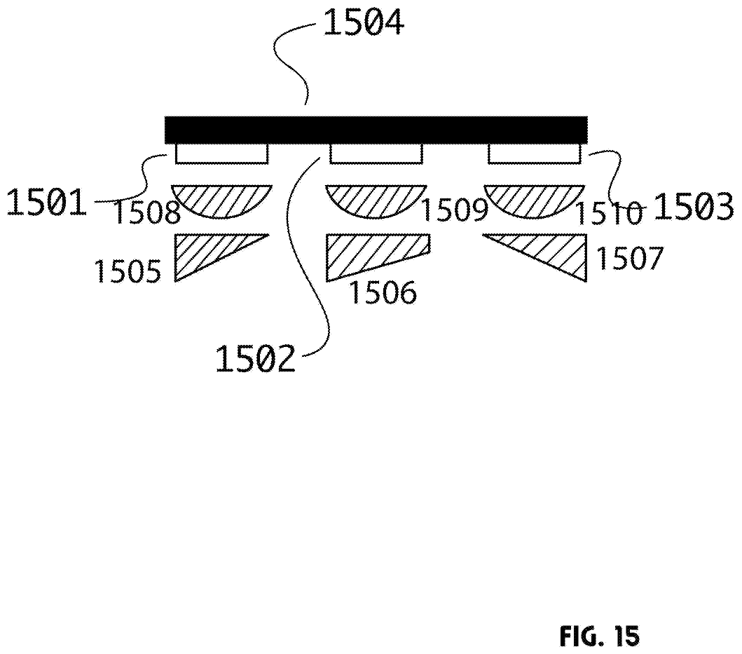

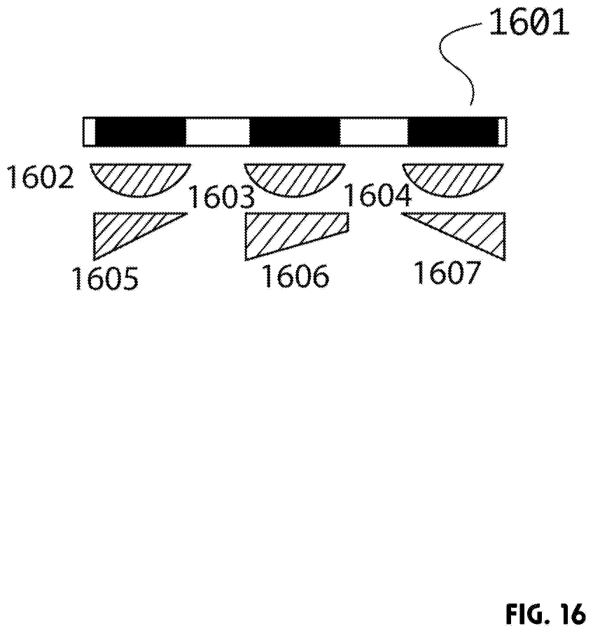

In the configuration in FIG. 14 it is possible to design a system so that the displays 1401, 1402, and 1403 are coplanar. FIG. 15 depicts an embodiment of the projection engine from FIG. 14 whereby the displays 1501, 1502, and 1503 are previously aligned and bonded to substrate 1504. FIG. 16 depicts another embodiment of such a projection engine where the displays are different regions of a large display 1601 having comparable dimensions and resolution to the combined displays. It is understood that there may be one or more large displays which each serve the purpose of two or more separate displays.

In the embodiments depicted in FIGS. 14˜16 it is understood that the number of displays could differ from three; it could be two or greater than three. It is further understood that the displays and projection engines could be in something other than a one dimensional array; it can be a rectangular or irregular two dimensional arrangement of projection engines.

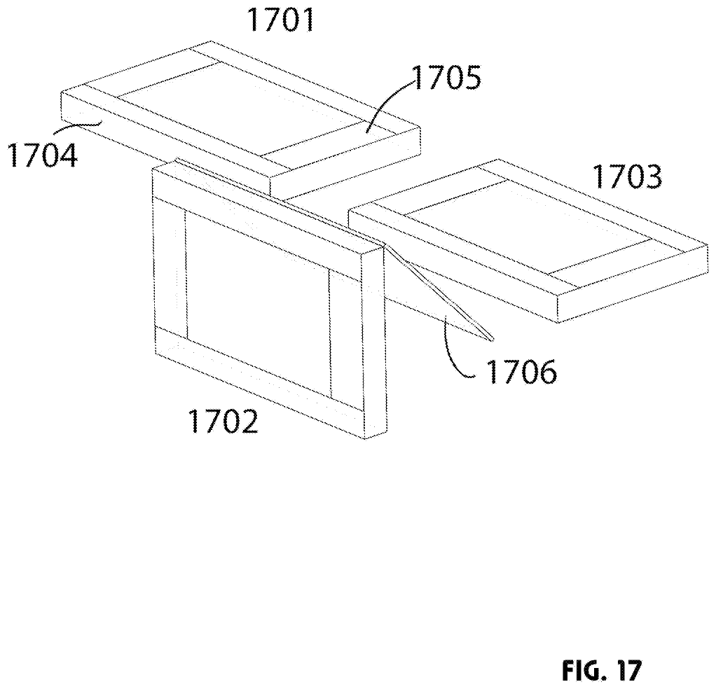

FIG. 17 depicts another embodiment a projection engine having multiple displays with displays 1701, 1702, and 1703. In order to accommodate the packaging 1704 and circuitry 1705 around the peripheral of the displays which causes them to be unabuttable, display 1702 reflects off a diagonal mirror 1706 which allows the output of the displays to be optically abutted against each other. It is understood that the number of displays need not be three; it could be two or greater than three, in which case every other display reflects off a diagonal mirror.

The projection engines in FIGS. 14˜17 can be combined with a waveguide or lightguide eyepiece, for example, those exemplified in FIGS. 5-9, to create a complete ARHS optical system capable of projecting an image to the wearer's eye. These include, but are not limited to, a projection engine of the type in FIG. 14 with a lightguide eyepiece having a sparse distribution of small mirrors as the out-coupling elements, a projection element of the type in FIG. 14 with a set of large, partially reflective mirrors as the out-coupling elements, a projection engine of the type in FIG. 14 with a waveguide eyepiece having a diffraction grating as the out-coupling element, a projection engine of the type in FIG. 15 with a lightguide eyepiece having a sparse distribution of small mirrors as the out-coupling elements, a projection element of the type in FIG. 15 with a set of large, partially reflective mirrors as the out-coupling elements, a projection engine of the type in FIG. 15 with a waveguide eyepiece having a diffraction grating as the out-coupling element, a projection engine of the type in FIG. 16 with a lightguide eyepiece having a sparse distribution of small mirrors as the out-coupling elements, a projection element of the type in FIG. 16 with a set of large, partially reflective mirrors as the out-coupling elements, a projection engine of the type in FIG. 16 with a waveguide eyepiece having a diffraction grating as the out-coupling element, a projection engine of the type in FIG. 17 with a lightguide eyepiece having a sparse distribution of small mirrors as the out-coupling elements, a projection element of the type in FIG. 17 with a set of large, partially reflective mirrors as the out-coupling elements, or a projection engine of the type in FIG. 17 with a waveguide eyepiece having a diffraction grating as the out-coupling element. In some embodiments combinations of waveguides are used to replicate the exit pupil of the projection engine in several directions to increase the eyebox size, and the waveguides used to replicate the exit pupil in different directions need not be of the same type. This type of system is capable of supporting a large field of view with a compact projection engine size, for example greater than 50-60 degrees field of view with a projection engine size under 20 mm high, and large eyebox size, for example greater than 10 mm in at least one direction.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. An augmented reality headset (ARHS) display system utilizing a projection engine which contains two or more displays, wherein the displays are each associated with a projection system, and wherein the displays and projection systems are aligned with each other to create a field-of-view (FOV) of at least 60 degrees.

2. The display system of claim 1, wherein the displays are microdisplays having a maximum dimension of less than 3 inches.

3. The display system of claim 1, wherein the displays are temporally multiplexed displays.

4. The display system of claim 1, wherein at least two of the displays are of different specifications.

5. The display system of claim 1, wherein a waveguide eyepiece is used in conjunction with the projection engine to redirect light into the viewer's eye.

6. The display system of claim 5, wherein the waveguide eyepiece contains a sparse distribution of small mirrors to redirect light into the viewer's eye.

7. The display system of claim 1, wherein prisms, or optical elements (for example, diffractive, Fresnel, or kinoform elements) having the same function as a prism are adjusted to align the sub-images formed by the several projection engines to within one-half of a pixel.

8. The display system of claim 1, wherein the two or more of the displays are coplanar.

9. The display system of claim 8, wherein the coplanar displays comprise separate devices aligned and packaged with the same planar substrate.

10. The display system of claim 8, wherein the coplanar displays comprise different regions of the same physical display with larger size.

11. The display system of claim 1, wherein optical prisms or mirrors are used to cause the displays to appear seamlessly abutted to each other in order to reduce the size and improve the field of view of the system.

12. The display system of claim 1, wherein the height of the projection engine is under 20 mm.

13. The display system of claim 1, wherein the eyebox has some dimension of at least 20 mm.

14. The display system of claim 7, wherein a waveguide eyepiece is used in conjunction with the projection engine to redirect light into the viewer's eye.

15. The display system of claim 14, wherein the waveguide eyepiece contains a sparse distribution of small mirrors to redirect light into the viewer's eye.

16. The display system of claim 8, wherein a waveguide eyepiece is used in conjunction with the projection engine to redirect light into the viewer's eye.

17. The display system of claim 16, wherein the waveguide eyepiece contains a sparse distribution of small mirrors to redirect light into the viewer's eye.

18. The display system of claim 11, wherein a waveguide eyepiece is used in conjunction with the projection engine to redirect light into the viewer's eye.

19. The display system of claim 18, wherein the waveguide eyepiece contains a sparse distribution of small mirrors to redirect light into the viewer's eye.

20. The display system of claim 10, wherein a waveguide eyepiece is used in conjunction with the projection engine to redirect light into the viewer's eye.
